(19) United States
(12) Patent Application Publication
(10) Pub. No.: US 2008/0049361 A1
(43) Pub. Date: Feb. 28, 2008

(54) Head suspension and head gimbal assembly

(75) Inventors: Hiroaki Kushima, Kawasaki (JP); Shinji Koganezawa, Kawasaki (JP); Takeshi Ohwe, Kawasaki (JP); Takuma Kido, Kawasaki (JP); Yasuo Suzuki, Kawasaki (JP)

Correspondence Address: Patrick G. Burns;GREER, BURNS & CRAIN, LTD., 300 South Wacker Drive, Suite 2500, Chicago, IL, 60606, US

(73) Assignee: FUJITSU LIMITED

(21) Appl. No.: 11/651,811

(22) Filed: Jan. 9, 2007

(30) Foreign Application Priority Data
Aug. 9, 2006 (JP) 2006-217299

(51) Int. Cl. G11B 5/48

(52) U.S. Cl. 360/245.8

(57) ABSTRACT

Connecting pieces extend outward from the support plate in the opposite directions along a crossline. A flexure body is connected to the connecting pieces. A pad is fixed to the support plate at a position ahead of the crossline. A wiring pattern extends from a pad. The wiring pattern defines a first straight portion extending forward from the flexure body along a first straight line. A second straight portion extends along a second straight line intersecting with the first straight line. A curved portion connects the first straight portion to the second straight portion. The curved portion expands outward from at least one of the first and second straight lines. The support plate merely suffers from a bending at a position ahead of the imaginary crossline even if the solder generates a stress based on its shrinkage. The wiring pattern serves to absorb the stress.

### BACKGROUND OF THE INVENTION

1. Field of the Invention

The present invention relates to a head gimbal assembly incorporated in a storage device such as a hard disk drive, HDD.

2. Description of the Prior Art

A head gimbal assembly is well known as disclosed in FIG. 6 of U.S. Pat. No. 6,965,499, for example. A flexure supports a head slider in the head gimbal assembly. An opening is formed at the front end of the flexure. An elongated plate extends to divide the opening. A support member is attached to the elongated plate. The support member is designed to extend over the opening. The electrically-conductive pad of a wiring pattern is located on the support member. The electrically-conductive pad is connected to the head slider. The wiring pattern is bent in the opening.

Solder is utilized to bond the electrically conductive pad to the head slider. The solder shrinks when the solder gets hardened. Since the support member is designed to extend over the opening, the flexure only suffers from a minimum stress from the support member. Moreover, the wiring pattern is bent in the opening, so that the stress causes deformation of the wiring pattern in the opening. This results in avoidance of deformation of the flexure. Any change can in this manner be avoided in the attitude of the head slider.

The support member is required to extend within the opening to get released from the generated stress. Specifically, the support member needs to be located on the elongated plate. The flexure is required to define a frame at a position outward from the wiring pattern so as to establish the opening and the elongated plate. This results in an increase in the size of the flexure. The increase in the size of the flexure tends to induce vibration in the flexure under the influence of airflow, for example. The vibration prevents the head slider from achievement of the accurate write/read operation.

### SUMMARY OF THE INVENTION

It is accordingly an object of the present invention to provide a head suspension and a head gimbal assembly of a reduced size for avoiding a change in the attitude of a head slider.

According to a first aspect of the present invention, there is provided a head suspension comprising: a support plate extending in the longitudinal direction, the support plate receiving a head slider; connecting pieces extending outward from the support plate in the opposite directions along an imaginary crossline extending in a direction intersecting with the longitudinal direction; a flexure body connected to the outer ends of the connecting pieces, the flexure body extending backward from the support plate, the flexure body received on a load beam; and a wiring pattern extending toward the flexure body from an electrically-conductive pad fixed to the support plate at a position ahead of the imaginary crossline, wherein the wiring pattern defines: a first straight portion extending forward from the flexure body along a first straight line; a second straight portion extending along a second straight line extending in a direction intersecting with the first straight line to reach the support plate; and a curved portion connecting the first and second straight portions to each other, the curved portion expanding outward from at least one of the first and second straight lines.

When a head slider is attached to the head suspension, the head slider is received on the support plate. The electrically-conductive pad is fixed to the support plate at a position ahead of the imaginary crossline. Solder is utilized to connect the head slider to the electrically-conductive pad, for example. The connecting pieces are designed to extend along the imaginary crossline. Since the electrically-conductive pad is fixed to the support plate at a position ahead of the imaginary crossline, the support plate merely suffers from a bending at a position ahead of the imaginary crossline even if the solder generates a stress based on its shrinkage. The wiring pattern is deformed at the curved portion. The wiring pattern serves to absorb the stress. The support plate is thus prevented from a bending at a position behind the imaginary crossline. The head slider is prevented from any change in the attitude. The attitude of the flying head slider can be set as designed.

Since the electrically-conductive pad is fixed on the support plate, the flexure body and the support plate are not required to define an opening and an elongated plate. It is thus unnecessary to form a frame in the flexure body at a position outward from the curved portion and the first and second straight portions of the wiring pattern. The flexure body can be made smaller. The flexure body of a smaller contour contributes to a reduction in the sizes of the head suspension and the aftermentioned head gimbal assembly. Even if the flexure body receives airflow, for example, the flexure body is prevented from suffering from vibration. This allows the head slider to achieve the accurate read/write operation.

The curved portion may extend along an arc having the center inside the intersecting first and second straight lines. In this case, the central angle may be set between 100 degrees and 180 degrees. The center may be located on the bisector of the intersecting angle of the first and second straight lines in the head suspension. Alternatively, the center may be located on a line normal to the first straight line. In addition, the curved portion may include at least partly a straight portion or portions. The straight portion may be defined at the intermediate position of the curved portion.

According to a second aspect of the present invention, there is provided a head gimbal assembly comprising: a head slider; an electrically-conductive terminal mounted on the head slider; a support plate extending in the longitudinal direction, the support plate receiving the head slider; connecting pieces extending outward from the support plate in the opposite directions along an imaginary crossline extending in a direction intersecting with the longitudinal direction; a flexure body connected to the outer ends of the connecting pieces, the flexure body extending backward from the support plate, the flexure body received on a load beam; a wiring pattern extending toward the flexure body from an electrically-conductive pad fixed to the support plate at a position ahead of the imaginary crossline; and a solder received on the electrically-conductive pad, the solder connected to the electrically-conductive terminal, wherein the wiring pattern defines: a first straight portion extending forward from the flexure body along a first straight line; a second straight portion extending along a second straight line, the second straight line extending in a direction intersecting with the first straight line to reach the support plate; and a curved portion connecting the first and second straight portions to each other, the curved portion expanding outward from at least one of the first and second straight lines.

The head slider is attached to the support plate for establishment of the head gimbal assembly. The electrically-conductive pad is fixed to the support plate at a position ahead of the imaginary crossline. Solder is utilized to connect the electrically-conductive terminal of the head slider to the electrically-conductive pad, for example. The connecting pieces are designed to extend along the imaginary crossline. Since the electrically-conductive pad is fixed to the support plate at a position ahead of the imaginary crossline, the support plate merely suffers from a bending at a position ahead of the imaginary crossline even if the solder generates a stress based on its shrinkage. The wiring pattern is deformed at the curved portion. The wiring pattern serves to absorb the stress. The support plate is thus prevented from a bending at a position behind the imaginary crossline. The head slider is prevented from any change in the attitude. The attitude of the flying head slider can be set as designed.

Since the electrically-conductive pad is fixed to the support plate, the flexure body and the support plate are not required to define an opening and an elongated plate. It is thus unnecessary to form a frame in the flexure body at a position outward from the curved portion and the first and second straight portions of the wiring pattern. The flexure body can be made smaller. The flexure body of a smaller contour contributes to a reduction in the sizes of the aforementioned head suspension and the head gimbal assembly. Even if the flexure body receives airflow, for example, the flexure body is prevented from suffering from vibration. This allows the head slider to achieve the accurate read/write operation.

According to a third aspect of the present invention, there is provided a storage device; a storage medium; a head slider opposed to the storage medium; an electrically-conductive terminal mounted on the head slider; a support plate extending in the longitudinal direction, the support plate receiving the head slider; connecting pieces extending outward from the support plate in the opposite directions along an imaginary crossline extending in a direction intersecting with the longitudinal direction; a flexure body connected to the outer ends of the connecting pieces, the flexure body extending backward from the support plate, the flexure body be received on a load beam; a wiring pattern extending toward the flexure body from an electrically-conductive pad fixed to the support plate at a position ahead of the imaginary crossline; and a solder received on the electrically-conductive pad, the solder connected to the electrically-conductive terminal, wherein the wiring pattern defines: a first straight portion extending forward from the flexure body along a first straight line; a second straight portion extending along a second straight line, the second straight line extending in a direction intersecting with the first straight line to reach the support plate; and a curved portion connecting the first and second straight portions to each other, the curved portion expanding outward from at least one of the first and second straight lines. The aforementioned head suspension and head suspension assembly may be incorporated in a storage device such as a hard disk drive in this manner.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive, HDD, as an example of a storage device according to the present invention;

FIG. 2 is a perspective view schematically illustrating a head gimbal assembly according to a first embodiment of the present invention;

FIG. 3 is an enlarged perspective view schematically illustrating the head gimbal assembly;

FIG. 4 is an enlarged partial sectional view taken along the line 4-4 in FIG. 3;

FIG. 5 is an enlarged partial plan view schematically illustrating the head gimbal assembly;

FIG. 6 is an enlarged partial plan view schematically illustrating a head gimbal assembly according to a second embodiment of the present invention;

FIG. 7 is an enlarged partial plan view schematically illustrating a head gimbal assembly according to a third embodiment of the present invention; and

FIG. 8 is an enlarged partial plan view schematically illustrating a head gimbal assembly according to a fourth embodiment of the present invention.

### DESCRIPTION OF THE PREFERRED EMBODIMENTS

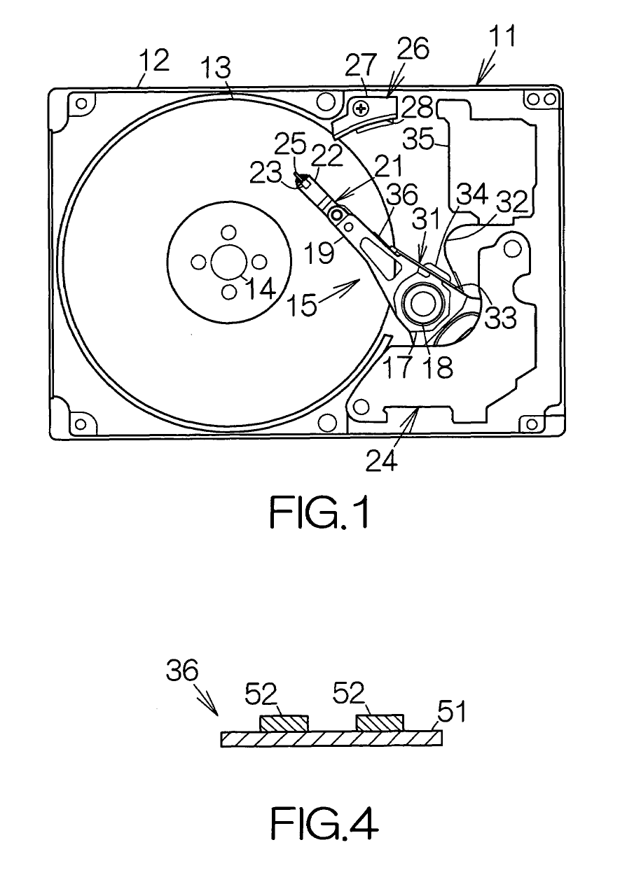

FIG. 1 schematically illustrates the inner structure of a hard disk drive, HDD, 11 as an example of a storage medium drive or a storage device according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A carriage 15 is also enclosed in the enclosure body 12. The carriage 15 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head gimbal assembly 21 is attached to the front or tip end of the individual carriage arm 19. The head gimbal assembly 21 is designed to extend forward from the carriage arm 19. The head gimbal assembly 21 includes a head suspension 22 extending forward from the carriage arm 19. The head suspension 22 exhibits a force urging the front or tip end thereof toward the surface of the magnetic recording disk 13. A flying head slider 23 is fixed to the tip end of the head suspension 22.

An electromagnetic transducer, not shown, is mounted on the flying head slider 23. The electromagnetic transducer may include a write element and a read element. The write element may include a thin film magnetic head designed to write magnetic bit data into the magnetic recording disk 13 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example.

When the magnetic recording disk 13 rotates, the flying head slider 23 is allowed to receive an airflow generated along the rotating magnetic recording disk 13. The airflow serves to generate a positive pressure or a lift as well as a negative pressure on the flying head slider 23. The flying head slider 23 is thus allowed to keep flying above the surface of the magnetic recording disk 13 during the rotation of the magnetic recording disk 13 at a higher stability established by the balance between the urging force of the head suspension 22 and the combination of the lift and the negative pressure.

A power source or voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspension assemblies 21 to swing. When the carriage arm 19 swings around the vertical support shaft 18 during the flight of the flying head slider 23, the flying head slider 23 is allowed to move along the radial direction of the magnetic recording disk 13. The electromagnetic transducer on the flying head slider 23 can thus be positioned right above a target recording track on the magnetic recording disk 13.

A load member or tab 25 is attached to the front or tip end of the individual head suspension 22. The load tab 25 is designed to extend further forward from the tip end of the head suspension 22. The swinging movement of the carriage 15 allows the load tab 25 to move along the radial direction of the magnetic recording disk 13. A ramp member 26 is located on the movement path of the load tab 25 in a space outside the magnetic recording disk 13. The load tab 25 is received on the surface of the ramp member 26.

The ramp member 26 includes an attachment base 27 fixed to the bottom plate of the enclosure body 12 at a position outside the magnetic recording disk 13. The attachment base 27 may be screwed in the bottom plate of the enclosure body 12. The ramp member 26 also includes ramps 28 extending in the horizontal direction from the attachment base 27 toward the vertical support shaft 18 of the carriage 15. The tip end of the individual ramp 28 is opposed to a non-data zone outside the outermost recording track on the magnetic recording disk 13. The ramp member 26 and the load tabs 25 in combination establish a so-called load/unload mechanism. The ramp member 26 may be made of a hard plastic material, for example.

A flexible printed circuit board unit 31 is located on the carriage block 17. The flexible printed circuit board unit 31 includes a first flexible printed wiring board 32. An adhesive may be utilized to attach the first flexible printed wiring board 32 to the surface of a metal plate 33 such as a stainless steel plate, for example. A screw or screws may be utilized to fix the metal plate 33 to the carriage block 17, for example.

A head IC (integrated circuit) 34 is mounted on the first flexible printed wiring board 32. The head IC 34 is designed to supply the read element with a sensing current when the magnetic bit data is to be read. The head IC 34 is also designed to supply the write element with a writing current when the magnetic bit data is to be written. A small-sized circuit board 35 is located within the inner space of the enclosure body 12. The small-sized circuit board 35 is designed to supply the head IC 34 with the sensing current and the writing current. A second flexible printed wiring board 36 is utilized to supply the sensing current and writing current. The second flexible printed wiring board 36 is related to the individual head suspension 22.

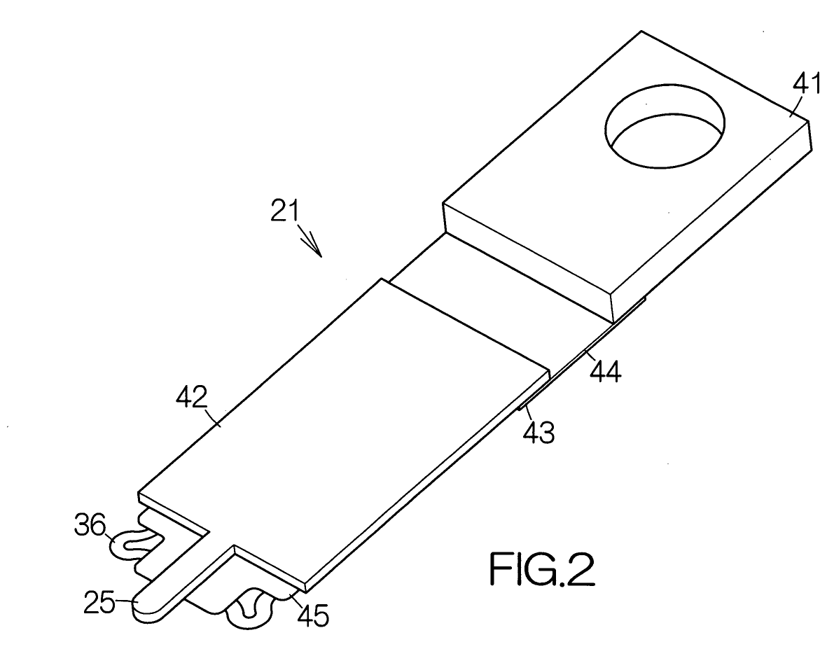

As shown in FIG. 2, the head gimbal assembly 21 includes a base plate 41 attached to the tip end of the carriage arm 19, and a load beam 42 distanced forward from the base plate 41 at a predetermined interval. Caulking process is employed to attach the base plate 41 to the carriage arm 19, for example. The aforementioned load tab 25 is defined in the tip end of the load beam 42. The load beam 42 is made of a metallic material lighter than stainless steel.

A hinge plate 43 is fixed to the front surfaces of the base plate 41 and the load beam 42. The hinge plate 43 includes an elastic bending section 44 between the front end of the base plate 41 and the rear end of the load beam 42. The hinge plate 43 serves to couple the base plate 41 with the load beam 42 in this manner. The hinge plate 43 is made of stainless steel, for example.

A flexure 45 is attached to the front surface of the load beam 42. The aforementioned second flexible printed wiring board 36 is attached to the surface of the flexure 45. The second flexible printed circuit board 36 is designed to extend backward from the front end of the load beam 42 toward the base plate 41. The flexure 45 may be made of stainless steel, for example. The flying head slider 23 is fixed to the surface of the flexure 45. Here, the base plate 41, the load beam 42 and the flexure 45 in combination establish the head suspension.

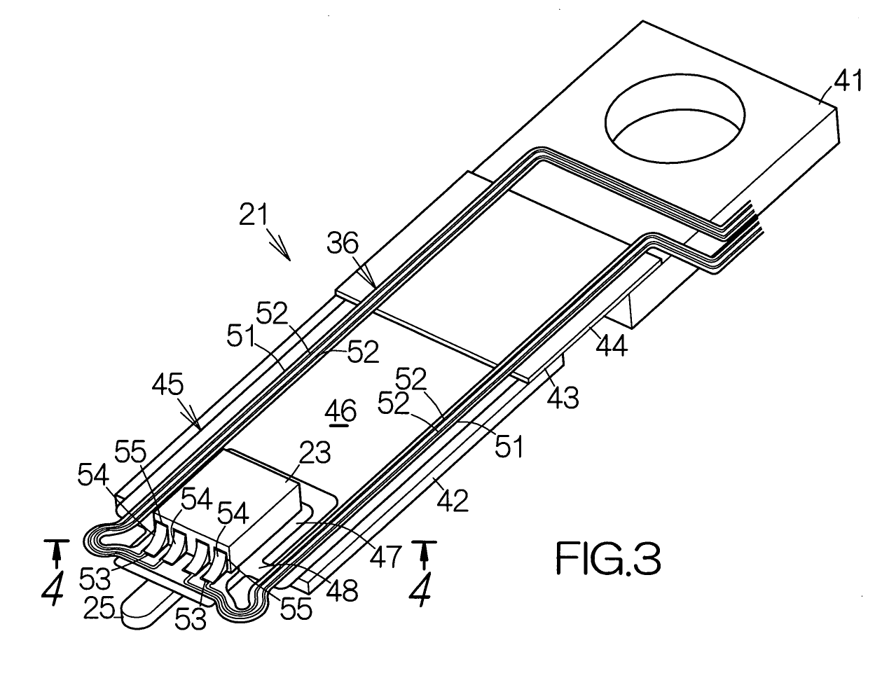

As shown in FIG. 3, the flexure 45 defines a flexure body 46 and a support plate 47. The flexure body 46 is supported on the surface of the load beam 42. The flying head slider 23 is supported on the front surface of the support plate 47. The support plate 47 is designed to extend in a longitudinal direction at a position forward from the flexure body 46. The flying head slider 23 may be attached to the front surface of the support plate 47. The flexure body 46 and the support plate 47 are connected to each other through connecting pieces 48. The flexure body 46, the support plate 47 and the connecting pieces 48 may be made of a sheet of a leaf spring material.

Referring also to FIG. 4, the second flexible printed wiring board 36 includes an insulating layer 51 and a wiring pattern 52 formed on the surface of the insulating layer 51. The insulating layer 51 may be made of a resin material such as polyimide resin or the like. The wiring pattern 52 may be made of a metallic material such as copper or the like. An electrically-conductive pad 53 is defined in the tip end of the wiring pattern 52. A solder 54 serves to connect the electrically-conductive pad 53 to an electrically-conductive terminal 55 mounted on the flying head slider 23. Here, four wiring patterns 52 are respectively connected to the electrically-conductive terminals 55. The electrically-conductive pads 53 and the solders 54 are located on the front surface of the support plate 47.

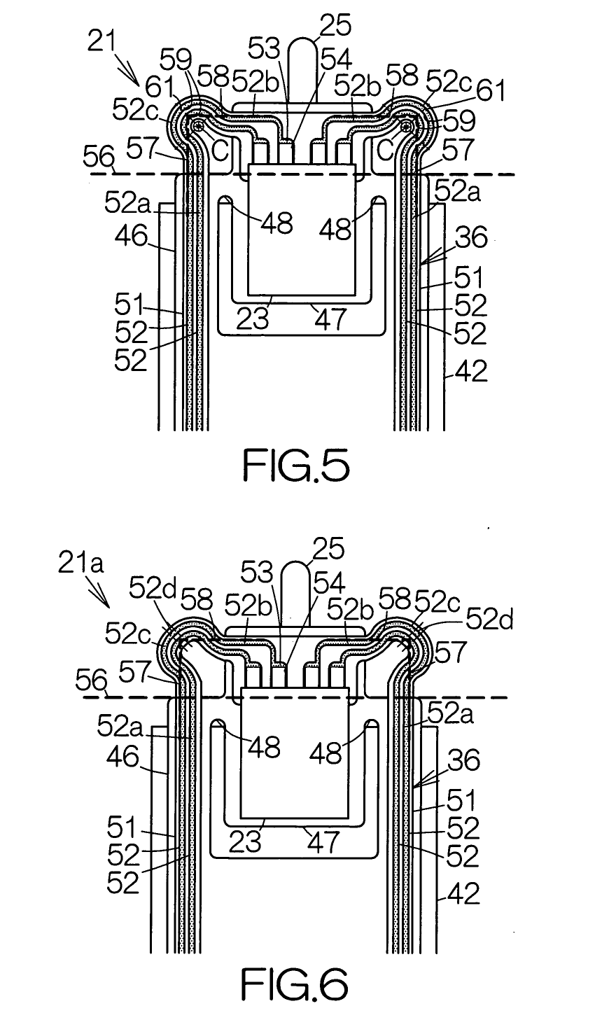

As shown in FIG. 5, the connecting pieces 48 protrude outward from the support plate 47 in the opposite directions along an imaginary crossline 56 extending in a direction intersecting with the longitudinal direction. The flexure body 46 is connected to the outer ends of the connecting pieces 48. The flexure body 46 is designed to extend backward from the connecting pieces 48. The electrically-conductive pads 53 and the solders 54 are located on the support plate 47 at a position ahead of the imaginary crossline 56. Here, the imaginary crossline 56 is designed to extend along the front edges of the connecting pieces 48 in parallel with the front end of the flying head slider 23. The imaginary crossline 56 may extend at a position adjacent to the front end of the flying head slider 23.

Each of the wiring patterns 52 is designed to extend from its tip end or the electrically-conductive pad 53 toward the flexure body 46. The wiring pattern 52 defines a first straight portion 52a, a second straight portion 52b and a curved portion 52c. The first straight portion 52a is designed to extend forward from the flexure body 46 along or in parallel with a first straight line 57. The second straight portion 52b is likewise designed to extend along or in parallel with a second straight line 58. The second straight line 58 extends in a direction intersecting with the first straight line 57 to reach the support plate 47. The curved portion 52c serves to connect the first and second straight portions 52a, 52b to each other. Here, the first straight line 57 may be perpendicular to the second straight line 58.

The first straight line 57 is defined along the outer edge of the outer one of the wiring patterns 52. The second straight line 58 is likewise defined along the outer edge of the outer one of the wiring patterns 52. The first straight line 57 intersects with the imaginary crossline 56. Here, the first straight line may be perpendicular to the imaginary crossline 56. The second straight line 58 may extend in parallel with the imaginary crossline 56. The curved portion 52c may expand outward from at least one of the first and second straight lines 57, 58. Here, the curved portion 52c expands outward from both the first and second straight lines 57, 58. The curved portion 52c is located at a position outward from the contours of the flexure body 46 and the support plate 47.

The curved portion 52c is designed to extend along a predetermined arc 59. The arc 59 has the center C on the bisector 61 of the intersecting angle of the first and second straight lines 57, 58. Here, the central angle of the arc 59 may be set at 180 degrees. The central angle of the arc 59 may at least be set equal to or larger than 100 degrees, for example. The central angle of the arc 59 is preferably set as large as possible so as to achieve a better absorption of stress, which will be described later. It should be noted that an increase in the central angle inevitably induces an increase in the length of the wiring pattern 52. The increase in the length of the wiring pattern 52 tends to cause vibration in the wiring pattern 52 under the influence of airflow, for example. Accordingly, vibration in the wiring pattern 52 should be taken into consideration in determination of the central angle.

The flying head slider 23, namely the back surface of the support plate 47 is received on a domed protrusion, not shown, formed on the surface of the load beam 42. The elastic bending section 44 of the hinge plate 43 exhibits a predetermined elastic force or bending force. The bending force enables application of an urging force to the front end of the load beam 42 toward the surface of the magnetic recording disk 13. The urging force is applied to the flying head slider 23 through the support plate 47 with the assistance of the domed protrusion. The flying head slider 23 is designed to change its attitude based on a lift resulting from the airflow. The protrusion allows such a change in the attitude of the flying head slider 23 or the support plate 47.

Here, a brief description will be made on a method of making the head gimbal assembly 21. The flying head slider 23 is attached to the front surface of the support plate 47 of the flexure 45. Spot welding is employed to couple the base plate 41, the load beam 42, the hinge plate 43 and the flexure 45 to one another, for example. The second flexible printed wiring board 36 is formed on the surface of the flexure 45. Etching process may be employed to form the second flexible printed wiring board 36. The first straight portion 52a is overlaid on the flexure body 46. The second straight portion 52b is overlaid on the support plate 47 at a position ahead of the imaginary crossline 56.

Solder is utilized to connect the electrically-conductive terminals 55 to the corresponding electrically-conductive pads 53. Heat is applied to melt the solder. The solder is then cooled to get hardened. The solder shrinks. The shrinkage generates a stress in the flexure 45. Since the electrically-conductive pads 53 are located on the front surface of the support plate 47 at a position ahead of the imaginary crossline 56, the stress causes a bending of the support plate 47 at a position ahead of the imaginary crossline 56. The wiring pattern 52 is deformed at the curved portion 52c so as to absorb the stress resulting from the shrinkage of the solder. The electrically-conductive terminals 55 are in this manner connected to the corresponding electrically-conductive pads 53.

The connecting pieces 48 extend along the imaginary crossline 56 in the head gimbal assembly 21. The electrically-conductive pads 53 are fixed to the support plate 47 at a position ahead of the imaginary crossline 56. When the electrically-conductive terminals 55 are soldered to the electrically-conductive pads 53, the shrinkage of the solder generates a stress in the aforementioned manner. The generated stress causes a bending of the support plate 47 at a position ahead of the imaginary crossline 56. The curved portion 52c serves to absorb the stress. This results in prevention of deformation of the support plate 47 at a position behind the imaginary crossline 56. The flying head slider 23 is thus prevented from any change in the pitch angle. The pitch angle of the flying head slider 23 can be set as designed.

Since the electrically-conductive pads 53 are fixed on the support plate 47, the flexure 45 is not required to define an opening and an elongated plate. It is thus unnecessary to form a frame in the flexure 45 at a position outward from the curved portions 52c and the first and second straight portions 52a, 52b of the wiring patterns 52. The flexure 45 can be made smaller. The flexure 45 of a smaller contour contributes to a reduction in the sizes of the head gimbal assembly 21 and the head suspension 22. Even if the flexure 45 receives airflow during the flight above the rotating magnetic recording disk 13, the flexure 45 is prevented from suffering from vibration. This allows the flying head slider 23 to achieve the accurate read/write operation.

Furthermore, the electrically-conductive pad 53 can be added to the front surface of the support plate 47 in a facilitated manner. A heater is incorporated in a flying head slider in recent years, for example. The heater is designed to generate heat so as to control the flying height of the flying head slider. The employment of the heater requires an additional pair of wiring pattern 52 and an additional pair of electrically-conductive pad 53. This results in six wiring patterns 52 on the second flexible printed wiring board 36. The head gimbal assembly 21 enables an increment of the wiring patterns 52 in a facilitated manner by simply adding the electrically-conductive pads 53.

As shown in FIG. 6, a head gimbal assembly 21a according to a second embodiment of the present invention may be attached to the carriage arm 19 in place of the aforementioned head gimbal assembly 21. A third straight portion 52d may be formed in the curved portion 52c of the wiring pattern 52 in the head gimbal assembly 21a. The third straight portion 52d may be defined at the intermediate position of the curved portion 52c, for example. Like reference numerals are attached to the structure or components equivalent to those of the aforementioned head gimbal assembly 21. The head gimbal assembly 21a achieves the aforementioned advantages.

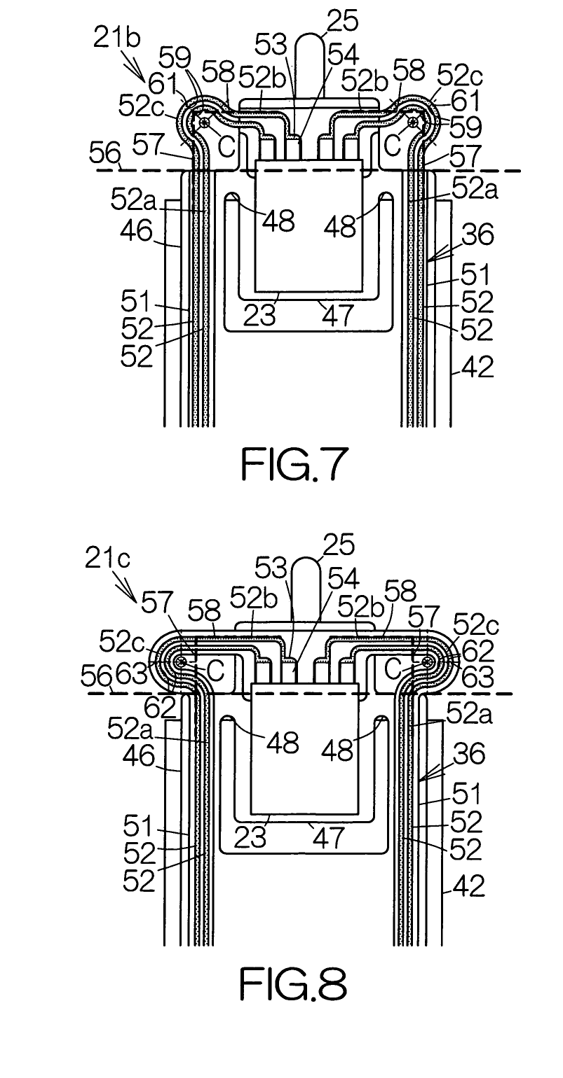

As shown in FIG. 7, a head gimbal assembly 21b according to a third embodiment of the present invention may be attached to the carriage arm 19 in place of the aforementioned head gimbal assemblies 21, 21a. The insulating layer 51 is removed from the curved portion 52c in the second flexible printed wiring board 36 of the head gimbal assembly 21b. Specifically, only the wiring pattern 52 extends at a position outward from the contours of the flexure body 46 and the support plate 47. Like reference numerals are attached to the structure or components equivalent to those of the aforementioned head gimbal assemblies 21, 21a.

The head gimbal assembly 21b allows a reduction in the rigidity of the second flexible printed wiring board 36 at a position outward from the contours of the flexure body 46 and the support plate 47. The wiring pattern 52 can thus absorb the stress with a higher efficiency. Furthermore, the curved portion 52c extends in an oblique direction along the bisector 61 at a position outward from the first and second straight lines 57, 58. This results in a reduction in the expansion of the curved portion 52c at a position outward from the first and second straight lines 57, 58 as compared with the case where the curved portion is designed to extend in directions along the first and second straight lines 57, 58 at a position outward from the first and second straight lines 57, 58. The curve portion 52c contributes to a reduction in the size of the head gimbal assembly 21b.

As shown in FIG. 8, a head gimbal assembly 21c according to a fourth embodiment of the present invention may be attached to the carriage arm 19 in place of the aforementioned head gimbal assemblies 21, 21a, 21b. The curved portion 52c may expand outward only from the first straight line 57 in the head gimbal assembly 21c. There may be no expansion of the curved portion 52c at a position outward from the second straight line 58. The curved portion 52c is designed to extend along a predetermined arc 62. The arc 62 has the center C on a line 63 normal to the first straight line 57. Here, the central angle of the arc 62 may be set at 180 degrees. The central angle of the arc 62 may at least be set equal to or larger than 100 degrees, for example. The central angle of the arc 62 is preferably set as large as possible. It should be noted that vibration in the wiring pattern 52 may be taken into consideration in determination of the central angle. Like reference numerals are attached to the structure or components equivalent to those of the aforementioned head gimbal assemblies 21, 21a, 21b.

The head gimbal assembly 21c achieves the aforementioned advantages. Moreover, the curved portion 52c is designed to extend in a direction along the second straight line 58 at a position outward from the first straight line 57. The second straight line 58 is defined outward from the front end of the flexure 45. There is no protrusion of the wiring pattern 52 forward from the front end of the flexure 45. This results in a reliable avoidance of contact between the wiring patterns 52 and the ramp member 26 when the load tab 25 is received on the ramps 28 of the ramp member 26. Damage of the wiring patterns 52 can be prevented.

What is claimed is:

1. A head suspension comprising:
a support plate extending in a longitudinal direction, said support plate receiving a head slider;
connecting pieces extending outward from the support plate in opposite directions along an imaginary crossline extending in a direction intersecting with the longitudinal direction;
a flexure body connected to outer ends of the connecting pieces, said flexure body extending backward from the support plate, said flexure body received on a load beam; and
a wiring pattern extending toward the flexure body from an electrically-conductive pad fixed to the support plate at a position ahead of the imaginary crossline, wherein
the wiring pattern defines:
a first straight portion extending forward from the flexure body along a first straight line;
a second straight portion extending along a second straight line intersecting with the first straight line to reach the support plate; and
a curved portion connecting the first and second straight portions to each other, said curved portion expanding outward from at least one of the first and second straight lines.

2. The head suspension according to claim 1, wherein the curved portion extends along an arc having a center inside the first and second straight lines, said arc having a central angle equal to or larger than 100 degrees.

3. The head suspension according to claim 2, wherein the arc has the center on a bisector of an intersecting angle of the first and second straight lines.

4. The head suspension according to claim 2, wherein the arc has the center on a line normal to the first straight line.

5. The head suspension according to claim 1, wherein the curved portion includes at least partly a straight portion.

6. The head suspension according to claim 5, wherein the straight portion is defined at the intermediate position of the curved portion.

7. A head gimbal assembly comprising:
a head slider;
an electrically-conductive terminal mounted on the head slider;
a support plate extending in a longitudinal direction, said support plate receiving the head slider;
connecting pieces extending outward from the support plate in opposite directions along an imaginary crossline extending in a direction intersecting with the longitudinal direction;
a flexure body connected to outer ends of the connecting pieces, said flexure body extending backward from the support plate, said flexure body received on a load beam;
a wiring pattern extending toward the flexure body from an electrically-conductive pad fixed to the support plate at a position ahead of the imaginary crossline; and
a solder received on the electrically-conductive pad, said solder connected to the electrically-conductive terminal, wherein
the wiring pattern defines:
a first straight portion extending forward from the flexure body along a first straight line;
a second straight portion extending along a second straight line intersecting with the first straight line to reach the support plate; and
a curved portion connecting the first and second straight portions to each other, said curved portion expanding outward from at least one of the first and second straight lines.

8. The head gimbal assembly according to claim 7, wherein the curved portion extends along an arc having a center inside the first and second straight lines, said arc having a central angle of 100 degrees.

9. The head gimbal assembly according to claim 8, wherein the arc has the center on a bisector of an intersecting angle of the first and second straight lines.

10. The head gimbal assembly according to claim 8, wherein the arc has the center on a line normal to the first straight line.

11. The head gimbal assembly according to claim 7, wherein the curved portion includes at least partly a straight portion.

12. The head gimbal assembly according to claim 11, wherein the straight portion is defined at the intermediate position of the curved portion.

13. A storage device comprising:
a storage medium;
a head slider opposed to the storage medium;
an electrically-conductive terminal mounted on the head slider;
a support plate extending in a longitudinal direction, said support plate receiving the head slider;
connecting pieces extending outward from the support plate in opposite directions along an imaginary crossline extending in a direction intersecting with the longitudinal direction;
a flexure body connected to outer ends of the connecting pieces, said flexure body extending backward from the support plate, said flexure body received on a load beam;
a wiring pattern extending toward the flexure body from an electrically-conductive pad fixed to the support plate at a position ahead of the imaginary crossline; and
a solder received on the electrically-conductive pad, said solder connected to the electrically-conductive terminal, wherein
the wiring pattern defines:
a first straight portion extending forward from the flexure body along a first straight line;
a second straight portion extending along a second straight line extending in a direction intersecting with the first straight line to reach the support plate; and
a curved portion connecting the first and second straight portions to each other, said curved portion expanding outward from at least one of the first and second straight lines.

14. The storage device according to claim 13, wherein the curved portion extends along an arc having a center inside the first and second straight lines, said arc having a central angle of 100 degrees.

15. The storage device according to claim 14, wherein the arc has the center on a bisector of an intersecting angle of the first and second straight lines.

16. The storage device according to claim 14, wherein the arc has the center on a line normal to the first straight line.

17. The storage device according to claim 13, wherein the curved portion includes at least partly a straight portion.

18. The storage device according to claim 17, wherein the straight portion is defined at the intermediate position of the curved portion.
